(19) United States
(12) Patent Application Publication
(10) Pub. No.: US 2024/0312422 A1
(43) Pub. Date: Sep. 19, 2024

(54) DISPLAY RESPONSE TIME UNIFORMITY AND PERFORMANCE

(71) Applicant: DELL PRODUCTS L.P., Round Rock, TX (US)

(72) Inventors: Hyunseok Ko, Singapore (SG); Eun Seok Kim, Singapore (SG)

(21) Appl. No.: 18/183,594

(22) Filed: Mar. 14, 2023

(51) Int. Cl. G09G 3/34; G09G 3/36

(52) U.S. Cl. CPC G09G 3/3426; G09G 3/36; G09G 2320/0252; G09G 2320/0626; G09G 2360/16

(57) ABSTRACT

A display device detects an event associated with a change in an overdrive strength setting of the display device. In response to determining that the change in the overdrive strength setting includes updating the overdrive strength setting for a fastest response time, the device determines whether a high dynamic range mode of the display device is enabled. If the high dynamic range mode is enabled, then the brightness of a backlight associated with the display device is increased to a maximum level.

### FIELD OF THE DISCLOSURE

The present disclosure generally relates to information handling systems and more particularly relates to an improvement in display response time uniformity and performance.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A display device detects an event associated with a change in an overdrive strength setting of the display device. In response to determining that the change in the overdrive strength setting includes updating the overdrive strength setting for a fastest response time, the device determines whether a high dynamic range mode of the display device is enabled. If the high dynamic range mode is enabled, then the brightness of a backlight associated with the display device is increased to a maximum level.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating a display device configured with improvements in response time uniformity and performance, according to an embodiment of the present disclosure;

FIG. 3 is a block diagram illustrating a liquid crystal display (LCD) panel divided into several zones, according to an embodiment of the present disclosure;

FIG. 4 is a block diagram illustrating an LCD panel divided into several zones, wherein each zone is associated with a weighting factor, according to an embodiment of the present disclosure;

FIG. 5 is a block diagram illustrating a system configured with improvements in response time uniformity and performance, according to an embodiment of the present disclosure;

FIG. 6 is an example of an overdrive lookup table, according to an embodiment of the present disclosure;

FIG. 7 is an example of a weighted overdrive lookup table, according to an embodiment of the present disclosure;

FIG. 8 is a block diagram illustrating a display device configured with improvements in response time uniformity and performance, according to an embodiment of the present disclosure; and

FIG. 9 is a flowchart illustrating a method for improving response time uniformity and performance, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

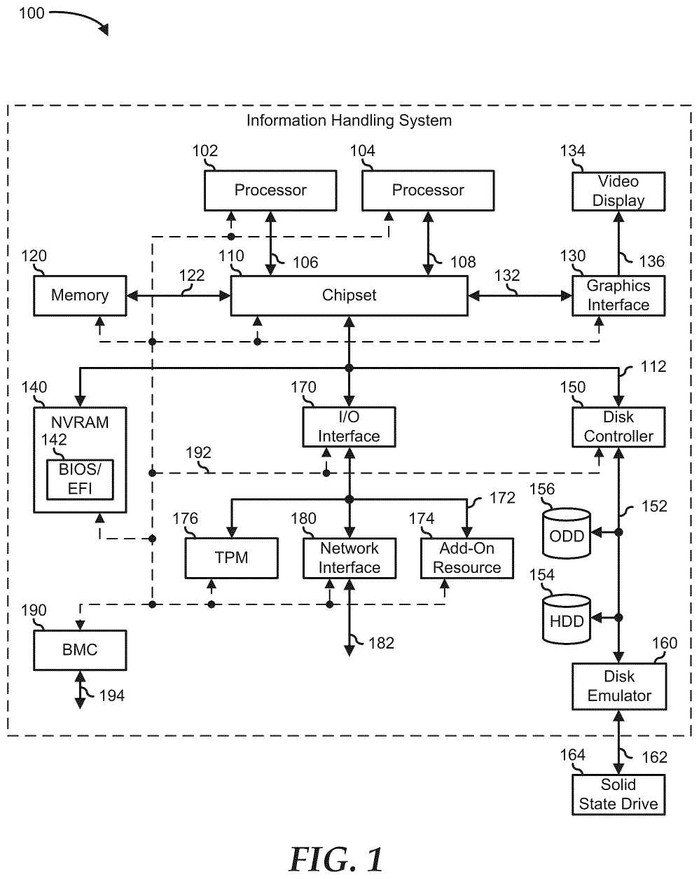

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to an add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth© or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an I²C bus, a System Management Bus (SMBus), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

A typical liquid crystal display (LCD) device, such as video display 134 of FIG. 1, uses a light-emitting diode (LED) bar at the bottom portion of a backlight chassis of the display device. The thermal profile of an LCD device shows different surface temperature levels, such that the surface temperature is generally higher at the bottom portion of the display where the LED bar is located as compared to the surface temperature at the top portion of the display, which is further from the LED bar. A response time of a display device, which is measured in milliseconds, is the amount of time it takes for pixels to change from one color to another. The response time may vary based on the surface temperature of the display device, wherein the response time is faster with a higher surface temperature. Accordingly, the response time around the bottom portion of the display device is typically faster than the response time around the top portion of the display device. To achieve a faster and a more uniform response time throughout the display device, the present disclosure provides a system and method to adjust the surface temperature of the display device, such that the surface temperature throughout the display device may be uniformly maintained at a desired surface temperature level. Because a faster response time is generally desired by users, specifically gamers, the improvement and uniformity in the response times would also increase user satisfaction.

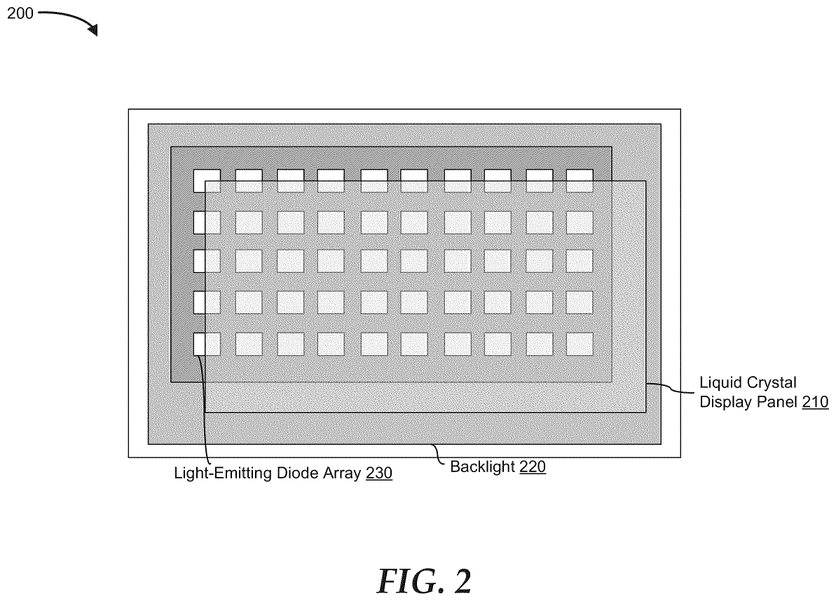

FIG. 2 shows a display device 200 configured with an improvement in display response time uniformity and performance. Display device 200 includes an LCD panel 210, a backlight 220, and an LED array 230. In various embodiments, display device 200 may not include each of the components shown in FIG. 2. Additionally, or alternatively, display device 200 may include various additional components in addition to those that are shown in FIG. 2.

Display device 200, which is similar to video display 134 of FIG. 1, may be any type of display device capable of receiving a signal from a source, such as a computer, a digital video disc player, etc., and then display images, video content, and/or graphical user interfaces on a display screen based on the received signal. Display device 200 may be an LCD device or similar display technology. Display device 200 may be associated with an information handling system such as information handling system 100 of FIG. 1. For example, display device 200 may be integrated within portable information handling systems configured in the form of a laptop, a notebook, a netbook, a tablet, or similar. Display device 200, maybe a separate device from the information handling system, such as in the form of a desktop monitor or similar.

LCD panel 210 may include any suitable system, device, or apparatus configured to display human-perceptible graphical data and/or alphanumeric data. LCD panel 210 may include an array of liquid crystals configured to modulate light generated by backlight 220 to create graphical data and/or alphanumeric data on LCD panel 210. Although FIG. 2 specifically depicts an LCD panel, in some embodiments, display device 200 may include another similar display panel.

Backlight 220 may include any system, device, or apparatus configured to generate light that may be modulated by LCD panel 210 to generate a display of the graphical data and/or alphanumeric data. Backlight 220 may be disposed behind LCD panel 210 within an enclosed chassis and output a controllable amount of light using LED, micro-LED, or similar light sources. The LED or micro-LED may be a white LED, or a red, green, and blue LED may be used as a light source. The light sources in LED array 230 may be arranged in a two-dimensional (2D) matrix in contrast to a typical backlight that includes a row of LEDs aligned along one edge of the backlight chassis. Backlight 220 may also include a thermal heat sink in a suitable location to sustain an increase in the surface temperature. For example, the heat sink may be used to dissipate the heat generated by the light sources.

The light sources may be arranged in various patterns, such as in a square or a rectangular matrix. The space between the light sources may also vary by design. The number and/or arrangement of light sources may vary based on the size of the LCD panel. In one example, there may be an array of 32×14 light sources for a total of 448 light sources. The increased number of light sources may lead to an increase in the surface temperature and higher brightness capability. With the increase of the surface temperature, the temperature of liquid crystal molecules in LCD panel 210 may also increase. This increase in temperature enables a faster response time as depicted in table 1 below.

As depicted in table 1, there may be differences in the response time between the different zones or locations in the LCD panel, such as between the bottom, center, and top portions of the LCD panel. For example, using backlight 220 at 1,000 nits, the response time at the bottom portion is 6.97 milliseconds while the response time is 6.26 milliseconds. In this example, the response time for the bottom portion of LCD panel 210 with backlight 220 at 1,000 nits is faster at 6.97 milliseconds compared to a response time of 8.08 milliseconds for the bottom portion of an LCD panel with a conventional backlight at 400 nits. The difference in the response time is a reduction of 13.8%. Similarly, the response time for the bottom portion of LCD panel 210 with backlight 220 at 1,000 nits is faster at 6.97 milliseconds compared to a response time of 8.03 milliseconds of the bottom portion of the LCD panel with backlight 220 at 400 nits. The difference in response time is a reduction of 1³0.3%. Similar reductions in response time may be seen at the center portion of the LCD panel and in the top portion of the LCD panel. For example, there is a reduction of 20.6% in the response time with backlight 220 at 1,000 nits compared to the response time of the conventional backlight at 400 nits. Similarly, there is a reduction of 21.6% in the response time with backlight 220 at 1,000 nits compared to the response time of the conventional backlight at 400 nits.

TABLE 1

| | Response Time Measured | | |
|---|---|---|---|
| | at Different Positions | | |
| | in the LCD Panel | | |
| | Bottom | Center | Top |
| Conventional Backlight at 400 nits | 8.08 ms | 8.12 ms | 8.22 ms |
| Backlight 220 at 400 nits | 8.03 ms | 7.88 ms | 7.84 ms |
| Backlight 220 at 1000 nits | 6.97 ms | 6.26 ms | 6.45 ms |

A weighting factor may be used to adjust the response time at the different portions or zones of the LCD panel such that the response times at these different locations may be similar or uniform. For example, one or more response times of backlight 220 at 1000 nits may be adjusted to be similar using weighting factors. In this example, the response times measured at the bottom and at the top of the LCD panel may be adjusted to be similar to the response time measured at the center of the LCD panel which is 6.26 ms. Accordingly, a weighting factor of 0.9 may be used to adjust the response time of 6.97 milliseconds at the bottom portion of the LCD panel resulting in a response time of 6.27 milliseconds, wherein 6.97 milliseconds*0.9=6.27 milliseconds. Similarly, a weighting factor of 0.97 may be used to adjust the response time of 6.45 milliseconds at the top portion of the LCD panel resulting in a response time of 6.25 milliseconds, wherein 6.45 milliseconds*0.97=6.25 milliseconds. Although in this example the response times of the bottom and top portions of the LCD panel are adjusted, one of skill in the art will appreciate that other response times may be adjusted, such as the response time at the center portion of the LCD panel may be adjusted to be similar to the response time at the top portion of the LCD panel.

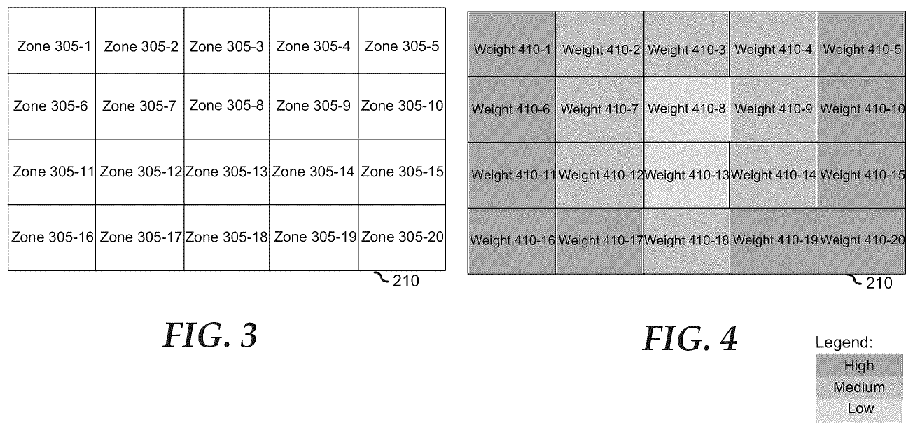

FIG. 3 shows LCD panel 210 divided into several zones. In this example, LCD panel 210 is divided into zones 305-1 through 305-20. The number of zones may be based on several factors, such as the size and resolution of the LCD panel 210. The number of zones shown here is an example and those of ordinary skill in the art will appreciate that the number of zones may be less than or greater than the number of zones in this example. Each zone may be associated with an adjustable weighting factor, as depicted in FIG. 4. The weighting factor may be used to independently optimize each zone's overdrive strength. The weighting factor may be used to adjust the degree of how much overdrive may be used in the calibrating of LCD panel 210 according to the thermal profile of the display device.

FIG. 4 shows LCD panel 210 divided into several zones and with different weighting factors associated with each zone, such as weight 410-1 through 410-20. The weighting factors may be adjusted based on the desired surface temperature and/or response times. A weighting factor may be associated with each zone so that the zone's overdrive strength can be optimized or calibrated independently according to a thermal profile. The weighting factor may be a weight given to a zone to assign the zone a lighter or heavier overdrive strength.

The weighting factors may be categorized into various categories, such as high, medium, and low. However, one skill in the art will appreciate that the categories depicted may vary. For example, weighting factors may have less than or more than the three categories depicted. In this example, wherein there are three weighting factor categories, assuming that the highest surface temperature is around the center portion of LCD panel 210 and has a faster response time than the top and bottom portions, a low weighting factor may be applied to the zones around the center portion, such as weighting factors 410-8 and 410-13. A medium weighting factor may be applied to zones next to the zones wherein the low weighting factor has been applied, such as weight factors 410-2, 410-3, 410. A high weighting factor may be applied to zones next to the zones wherein the medium weighting factor has been applied.

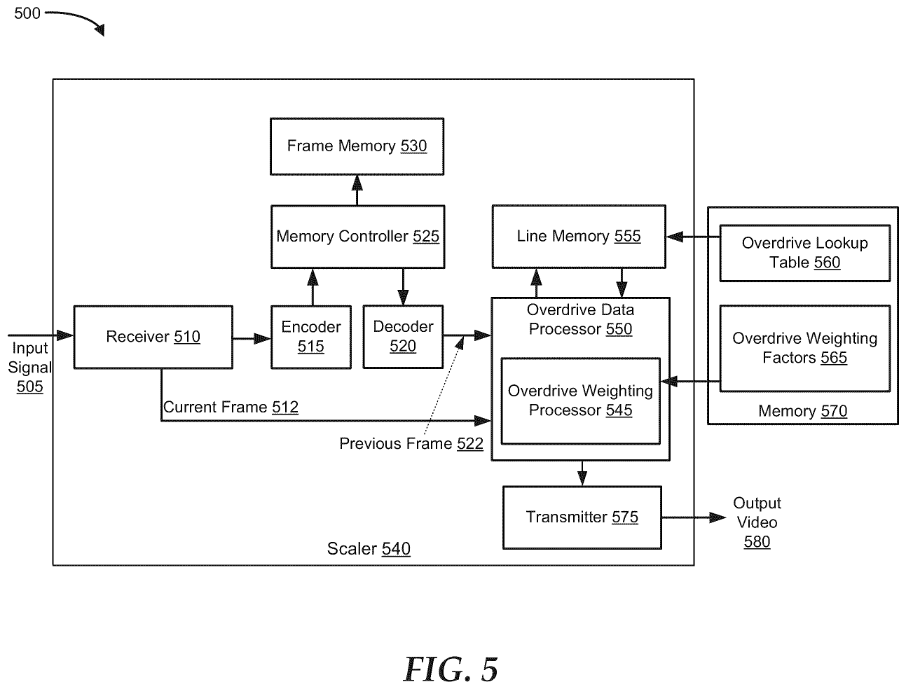

FIG. 5 shows a system 500 for improving response time uniformity and performance. System 500 includes a scaler 540, a memory 570, and a transmitter 575. In various embodiments, system 500 may not include each of the components shown in FIG. 5. Additionally, or alternatively, system 500 may include various additional components in addition to those that are shown in FIG. 5. Furthermore, some components that are represented as separate components in FIG. 5 may in certain embodiments instead are integrated with other components. For example, in certain embodiments, all or a portion of the functionality provided by the illustrated components may instead be provided by components integrated into one or more processor(s) as a system-on-a-chip.

Receiver 510 may be configured to receive signals, such as input signal 505, from various sources, such as an information handling system. The received signal, which includes current frame 512, may be transmitted to overdrive data processor 550 and encoder 515 for encoding. Encoder 515 then transmits the signal to memory controller 525 which then transmits the video input signal to frame memory 530. Memory controller 525 may be configured to control the write/read of frame data to frame memory 530. Frame memory 530, also referred to as a frame buffer, may be a memory that stores a signal of an image to be displayed on an LCD panel, such as LCD panel 210 of FIG. 2. Memory controller 525 may retrieve the encoded signal from frame memory 530 and transmit it to decoder 520 for processing. Decoder 520 may be configured to decode the received signal and transmit the decoded signal to overdrive data processor 550 which includes an overdrive weighting processor 545. At this point, the decoded signal includes a previous frame 522. Transmitter 575 may be configured to transmit output video 580 to a timing controller for display.

Overdrive data processor 550 may retrieve overdrive lookup table 560 from memory 570 based on the current overdrive drive setting of the display device, current frame 512, and previous frame 522. Overdrive lookup table 560 and overdrive weighting factors 565 may be stored in line memory 555. Line memory 555 may be an NV-RAM used to store overdrive lookup table values, such as overdrive lookup table 560, for real-time data processing. Memory 570 may be a non-volatile memory such as an erasable programmable read-only memory (EEPROM) also referred to as a flash memory. Memory 570 may be used to store overdrive lookup tables and overdrive weighting factors. In another embodiment, memory 570 may be used to store several overdrive weighted lookup tables, wherein each overdrive weighted lookup table may have values wherein a weighting factor has been applied, such as overdrive lookup table 700 of FIG. 7.

Overdrive lookup table 560 may be one of a plurality of lookup tables stored in memory 570. The overdrive lookup tables include overdrive values to support the overdrive settings including response times associated with the LCD panel. Overdrive weighting factors 565 may be used to adjust or manipulate the overdrive values in the overdrive lookup table values resulting in uniformity of response times at different zones of the LCD panel. Overdrive weighting processor 545 may be configured to determine and apply the overdrive weighting factors to the overdrive values in overdrive lookup table 560 before storing it in line memory 555.

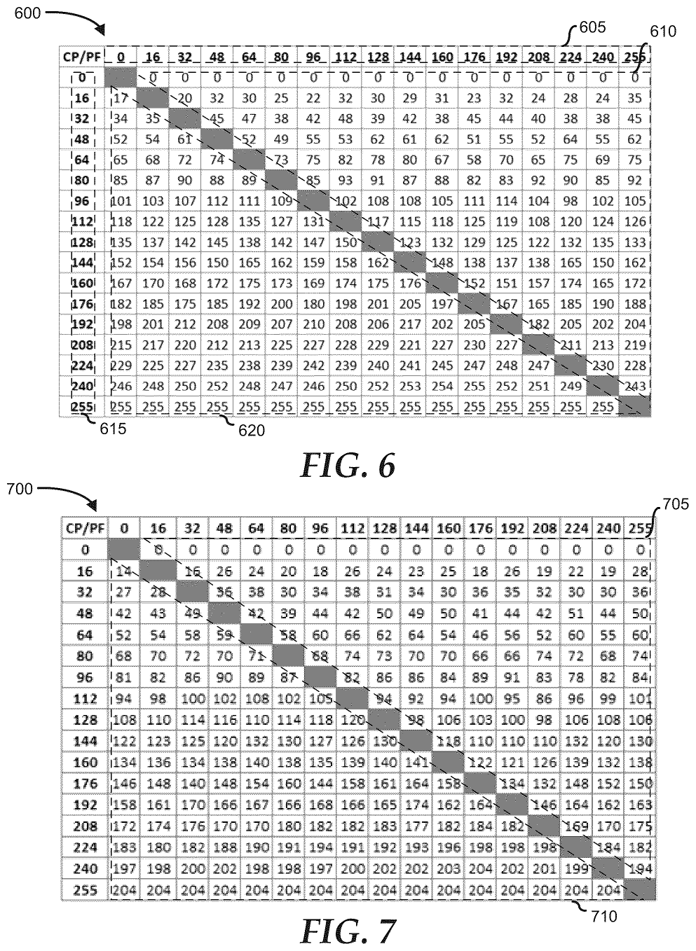

FIG. 6 shows an example of an overdrive lookup table 600 which is similar to overdrive lookup table 560 of FIG. 5. Overdrive lookup table 600 includes gray levels 605 of the previous frame and gray levels 615 of the current frame. Overdrive lookup table 600 also includes overdrive values 610 for falling edges and overdrive values 620 for rising edges. Overdrive lookup table 600 may also be an example of an overdrive weighted lookup table, wherein the weighting factor is one. The weighting factor of one may be an example of a weighting factor in the high category as depicted in FIG. 4. Overdrive lookup table 600 may be used to describe how much voltage is to be applied to each zone in the LCD panel. The liquid crystals may change their state based on the applied voltage which in turn causes the response time to change.

FIG. 7 shows an example of a weighted overdrive lookup table 700 based on overdrive lookup table 600 of FIG. 6. A weighting factor of 0.8 is applied to the values of overdrive lookup table 600 of FIG. 6 as depicted in overdrive values 705 and 710. The weighting factor of 0.8 may be an example of a weighting factor in the medium category depicted in FIG. 4. The overdrive weighting factor may be used to adjust the voltage before the voltage is applied to each zone to the LCD panel. A weighting factor of less than 0.8 may be an example of a weighting factor in the low category depicted in FIG. 4. Those of ordinary skill in the art will appreciate the examples of weighting factors shown in FIG. 6 and FIG. 7 do not limit the present disclosure and the weighting factors associated with each category may vary.

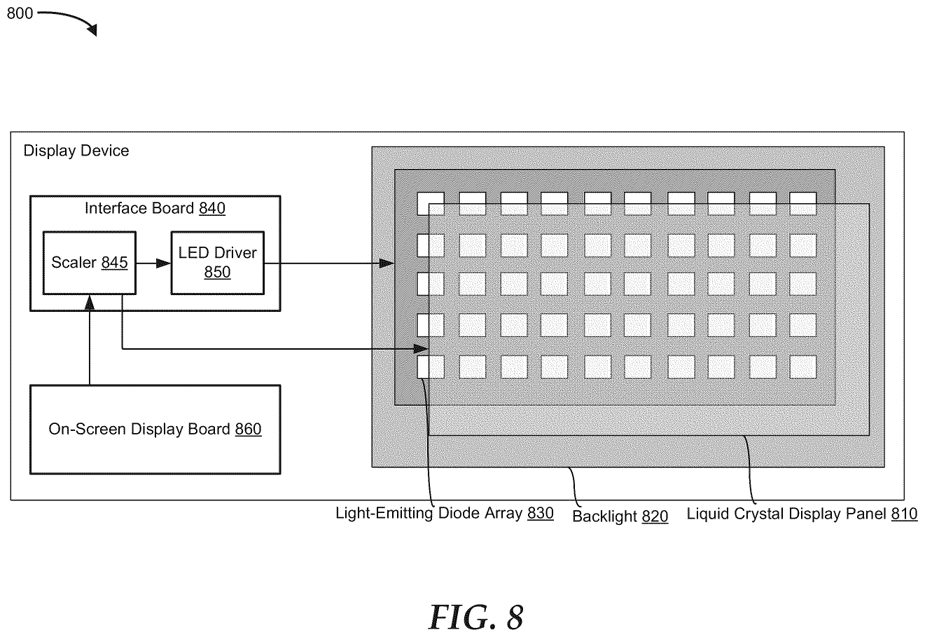

FIG. 8 shows a display device 800 configured with an improvement in response time uniformity and performance. Display device 800, which is similar to display device 200 of FIG. 2, includes an LCD panel 810, a backlight 820, an LED array 830, an interface board 840, and an on-screen display board 860. Interface board 840 includes a scaler 845 and an LED driver 850. Scaler 845 is similar to scaler 540 of FIG. 5. LCD panel 810 is similar to LCD panel 210 of FIG. 2. Backlight 820 is similar to backlight 220 of FIG. 2. LED array 830 is similar to LED array 230 of FIG. 2. Interface board 840 may be communicatively coupled to backlight 820, LED array 830, and LCD panel 810. On-screen display board 860 may be communicatively coupled to interface board 840.

In various embodiments, display device 800 may not include each of the components shown in FIG. 8. Additionally, or alternatively, display device 800 may include various additional components in addition to those that are shown in FIG. 8. Furthermore, some components that are represented as separate components in FIG. 8 may in certain embodiments instead be integrated with other components. For example, in certain embodiments, all or a portion of the functionality provided by the illustrated components may instead be provided by components integrated into one or more processor(s) as a system-on-a-chip.

Interface board 840 may be configured to provide control to LCD panel 810, backlight 820, and LED array 830. A change in the overdrive strength to the fastest response time may trigger scaler 845 to transmit a boost-enable signal to LED driver 850 and the overdrive data processor. Upon receipt of the boost-enable signal, LED driver 850 may set the brightness level of the display device to maximum by increasing the current to the light sources in the backlight. In addition, the backlight dimming feature may also be disabled when the high dynamic range (HDR) mode is enabled. The boost-enable signal may also turn on the overdrive data processor to apply different overdrive values to the different zones of the display device or in particular of the LCD panel. Weighting factors may be applied to the overdrive values prior to applying them to the different zones. The weighting factors may be used to provide uniformity in the response time among the different zones of the display device.

On-screen display board 860 may include an on-screen display menu that includes one or more adjustments for ease of setup and screen optimization of LCD panel 810. The on-screen display menu includes a menu to adjust an overdrive setting, such as the response time, wherein a user can select between one or more response times. For example, the user can select among normal, fast, or extremely fast response times also referred to as extreme mode. The extreme mode may be the fastest response time among the different modes. The selected response time may be transmitted by on-screen display board 860 to scaler 845. Based on the selected response time, scaler 845 may transmit a boost-enable signal to LED driver 850. The boost-enable signal may trigger an increase in the backlight brightness level by LED driver 850. The boost-enable signal may also then turn on the overdrive data processor and weighting factors to the overdrive values which are based on an overdrive lookup table.

Those of ordinary skill in the art will appreciate that the configuration, hardware, and/or software components of system 500 depicted in FIG. 5 and display device 800 of FIG. 8 may vary. For example, the illustrative components of system 500 and display device 800 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for the continuity of the description.

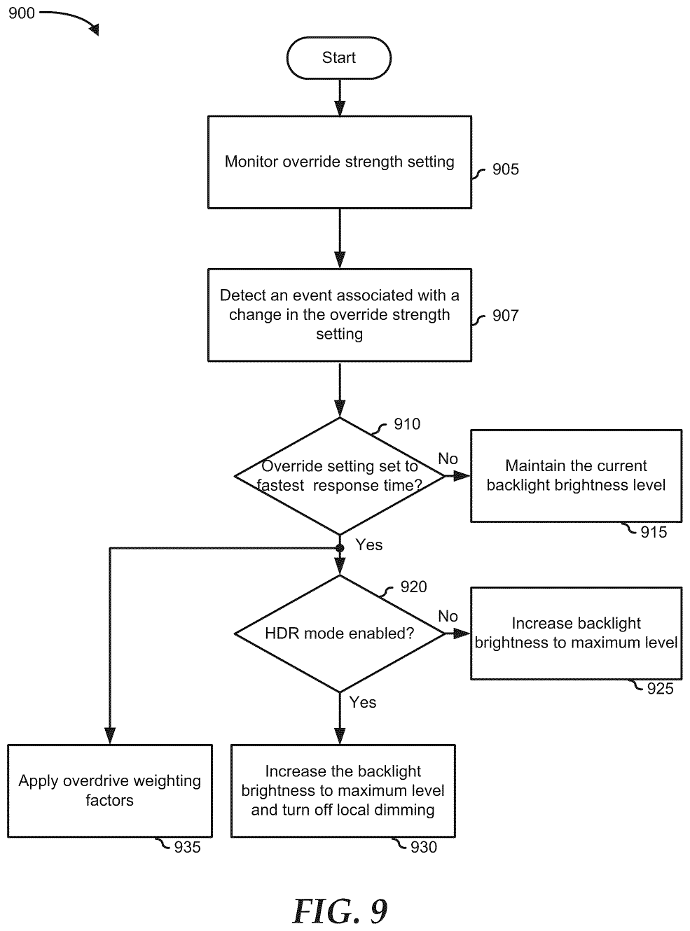

FIG. 9 shows a flowchart of a method 900 for improving response time uniformity and performance. Method 900 may be performed by one or more components of system 500 of FIG. 5 and/or display device 800 of FIG. 8. For example, one or more blocks of method 900 may be performed by scaler 540 of FIG. 5 and LED driver 850 of FIG. 8. However, while embodiments of the present disclosure are described in terms of system 500 of FIG. 5 and display device 800 of FIG. 8, it should be recognized that other systems or display devices may be utilized to perform the described method. One of skill in the art will appreciate that this flowchart explains a typical example, which can be extended to advanced applications or services in practice.

Method 900 typically starts at block 905 where the method may monitor an overdrive strength setting. In one embodiment, the method may monitor the current overdrive strength setting to detect whether there is a change in the overdrive strength setting, also referred to as an overdrive setting. In another embodiment, the method may periodically determine the current setting of the overdrive strength. The method may proceed to block 907 where it detects an event associated with a change in the overdrive strength setting. In one embodiment, a user may change the overdrive strength setting.

Subsequent to detecting the event, the method may proceed to decision block 910 to determine whether a response time setting of the overdrive strength setting is set to the fastest response time. If the overdrive strength setting is set to the fastest response time, then the “YES” branch is taken, and the method proceeds to decision block 920. If the overdrive strength setting is not set to the fastest response time, then the “NO” branch is taken, and the method proceeds to block 915.

At block 915, the method maintains the current brightness level of the light sources in the backlight. At decision block 920, the method determines whether the HDR mode is enabled. If the HDR mode is enabled, then the “YES” branch is taken, and the method proceeds to block 930. If the HDR mode is not enabled, then the “NO” branch is taken, and the method proceeds to block 925.

At block 915, the method may maintain the current brightness level of the backlight. At block 925, the method may increase the brightness of the backlight to the maximum level. At block 930, the method may increase the brightness of the backlight to the maximum level and turn off a local dimming feature of the backlight. At block 935, the method may enable the overdrive data processor to apply different weighting factors to the zones in the display device or the LCD panel in particular.

The term “user” in this context should be understood to encompass, by way of example and without limitation, a user device, an application, a person utilizing or otherwise associated with the device or the application, or a combination of the aforementioned. An operation described herein as being performed by a user may therefore be performed by a user device or application, or by a combination of the person, application, and device.

As used herein, a hyphenated form of a reference numeral refers to a specific instance of an element and the un-hyphenated form of the reference numeral refers to the collective or generic element. Thus, for example, zones “305-1” refers to an instance of a zone class, which may be referred to collectively as zones “305” and any one of which may be referred to generically as a widget “305.”

Although FIG. 9 shows example blocks of method 900 and method 900 in some implementations, method 900 may include additional blocks, fewer blocks, different blocks, or differently arranged blocks than those depicted in FIG. 9. Those skilled in the art will understand that the principles presented herein may be implemented in any suitably arranged processing system. Additionally, or alternatively, two or more of the blocks of method 900 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

1. A method comprising:
detecting, by a processor, an event associated with a change in an overdrive strength setting of a display device;
in response to determining that the change in the overdrive strength setting includes updating the overdrive strength setting for a fastest response time, determining whether a high dynamic range mode of the display device is enabled; and
in response to determining that the high dynamic range mode is enabled, increasing brightness of a backlight associated with the display device to a maximum level and applying different weighting factors to different zones of the display device based on surface temperature of the different zones.

2. The method of claim 1, wherein a lower weighting factors is applied to a first set of zones in a center location of the display device and a higher weighting factor is applied to a second set of zones around the first set of zones.

3. The method of claim 1, wherein the different weighting factors are used to adjust lookup table values that support overdrive settings.

4. The method of claim 1, applying a first weighting factor to a first zone located around a center portion of the display device and applying a second weighting factor to a second zone located around a bottom portion of the display device.

5. The method of claim 1, further comprising turning off a local dimming feature of the backlight in addition to increasing the brightness of the backlight.

6. The method of claim 1, further comprising in response to determining that the overdrive strength setting is not set at the fastest response time, maintaining current brightness level of the backlight.

7. The method of claim 1, wherein the backlight includes a two-dimensional array of light-emitting diodes.

8. A display device, comprising:
a processor; and
a memory storing code that when executed causes the processor to perform operations, the operations including:
detecting an event associated with a change in an overdrive strength setting of the display device;
in response to determining that the change in the overdrive strength setting includes updating the overdrive strength setting for a fastest response time, determining whether a high dynamic range mode of the display device is enabled; and
in response to determining that the high dynamic range mode is enabled, increasing brightness of a backlight associated with the display device to a maximum level and applying different weighting factors to different zones of the display device based on surface temperature of the different zones.

9. The display device of claim 8, wherein a lower weighting factor is applied to a first set of zones along a center location of the display device and a higher weight factor is applied to a second set of zones around the first set of zones.

10. The display device of claim 9, wherein the different weighting factors are used to adjust lookup table values that support overdrive settings.

11. The display device of claim 8, wherein the operations further comprise applying a first weighting factor to a zone located around a center portion of the display device and a second weighting factor to a second zone located around a top portion of the display device.

12. The display device of claim 8, wherein the operations further comprise turning off a local dimming feature of the backlight in addition to increasing the brightness of the backlight.

13. The display device of claim 8, wherein the operations further comprise in response to determining that the high dynamic range mode is enabled, increasing the brightness of the backlight to maximum.

14. The display device of claim 8, wherein the display device includes a two-dimensional array of light-emitting diodes.

15. A non-transitory computer-readable medium to store instructions that are executable to perform operations comprising:
detecting an event associated with a change in an overdrive strength setting of a display device;
if the change in the overdrive strength setting includes updating the overdrive strength setting for a fastest response time, then determining whether a high dynamic range mode of the display device is enabled; and
if the high dynamic range mode is enabled, then increasing brightness of light sources in a backlight of the display device to a maximum level and applying different weighting factors to different zones of the display device based on surface temperature of the different zones.

16. The non-transitory computer-readable medium of claim 15, wherein a lower weighting factor is applied to a first set of zones associated with the display device and a higher weighting factor is applied to a second set of zones around the first set of zones.

17. The non-transitory computer-readable medium of claim 15, wherein the different weighting factors are used to adjust lookup table values that support overdrive settings.

18. The non-transitory computer-readable medium of claim 15, wherein the operations further comprise applying a first weighting factor to a first zone located around a center portion of the display device and a second weighting factor to a second zone located around a top portion of the display device.

19. The non-transitory computer-readable medium of claim 15, wherein the operations further comprise turning off a local dimming feature of the backlight in addition to increasing the brightness of the backlight.

20. The non-transitory computer-readable medium of claim 15, wherein the operations further comprise in response to determining that the overdrive strength setting is not set at the fastest response time, maintaining current brightness level of the backlight.
